(19) United States
(12) Patent Application Publication
(10) Pub. No.: US 2002/0112561 A1
(43) Pub. Date: Aug. 22, 2002

(54) Angle adjuster for the grip of a golf cart

(76) Inventor: Gordon Liao, Yung Kang City (TW)

Correspondence Address: Keith Kline, PRO-TECHTOR INTERNATIONAL SERVICES, 20775 Norada Court, Saratoga, CA, 95070-3018, US

(21) Appl. No.: 09/777,493

(22) Filed: Feb. 5, 2001

(51) Int. Cl. B62K 21/16

(52) U.S. Cl. 74/551.3

(57) ABSTRACT

An angle-adjuster for the grip of a golf-cart includes a grip with two ends respectively fixed with two rod bases having plural deep and shallow grooves arrange spaced apart equidistantly in two opposite inner sides, gear discs at back sides having a center shaft holes, an adjusting member provided between two rod bases and having projections corresponding to the grooves of the rod bases and the protruding-out portion of the projection longer than the depth of the shallow groove but shorter than the deep groove of the rod base, two elastic members respectively fitted in the inner side of the gear disc of the rod base, and two connect bases respectively compressing the elastic member and resting against the rod base and then a position member inserting through them and fixing them in position, and two connect bases also having gear discs corresponding to the gear discs of the rod bases for mutual engagement. Thus, the angle of the grip can easily be adjusted by mans of the adjusting member.

### BACKGROUND OF THE INVENTION

This invention relates to an angle-adjuster for the grip of a golf-cart, particularly to one possible to adjust its angle with ease and handle it with convenience.

A known conventional angle-adjuster for the grip of a golf-cart, as shown in FIG. 1, includes a grip rod 1 provided on a top side with a grip base 2 having a lateral hole on a top side and a gear disc 3 fixed on the inner side of the hole, and then nearly U-shaped grip 4 provided on the grip base 2, and having a gear disc 5 of the same shape as and engaging the gear disc 3 of the grip base 2 for mutual engagement. The gear disc 5 also has a center threaded hole. Then a spiral base 6 with a threaded rod is inserted into the hole of the grip base 2 and through the center threaded hole of the grip 4 and kept positioned therein.

In accordance with the known conventional device, to adjust the angle of the grip, the spiral base 6 has to be loosened first to let two gear discs 3 and 5 separate from each other for facilitating angle adjustment, but, after a needed angle is acquired, the spiral base 6 must be turned tightly again to permit two gear discs 3 and 5 restore engagement.

As can be noted from the above description, the known conventional way of adjusting the angle of a grip has several disadvantages as follows;

1. The spiral base 6 has to be turned repeatedly to let two gear discs 3 and 5 separate from each other, inconvenient in handling.

2. In case of the spiral base 6 not tightly turned locked, the grip 4 is liable to loosen from the grip base 2.

3. If the spiral base 6 is released excessively, the spiral base 6 together with its threaded rod will fall off, rendering the grip ineffectual.

### SUMMARY OF THE INVENTION

The objective of the invention is to offer an angle adjuster for the grip of a golf cart, much better in structure and more convenient in handling than the known conventional one mentioned above.

### BRIEF DESCRIPTION OF DRAWINGS

This invention will be better understood by referring to the accompanying drawings, wherein:

FIG. 1 is a perspective view of a known conventional angle adjuster for the grip of a golf cart:

FIG. 2 is a perspective view of an angle adjuster for the grip of a golf cart in the present invention:

FIG. 3 is an exploded perspective view of the angle adjuster for the grip of a golf cart in the present invention:

FIG. 4 is a perspective view of the inner side of a rod base of the angle adjuster in the present invention:

FIG. 5 is another perspective view of the backward side of the rod base of the angle adjuster in the present invention:

FIG. 6 is a perspective view of an adjusting member of the angle adjuster in the present invention:

FIG. 7 is a side cross-sectional view of the grip in the locked position in the present invention:

FIG. 8 is a side cross-sectional view of the grip of in the unlocked condition in the present invention:

FIG. 9 is a perspective view of the grip of unlocked condition in the present invention:

FIG. 10 is a perspective view of the grip of locked condition in the present invention:

FIG. 11 is a perspective view of the grip provided with an appended umbrella base in the present invention:

FIG. 12 is a perspective view of the grip provided with another position member in the present invention.

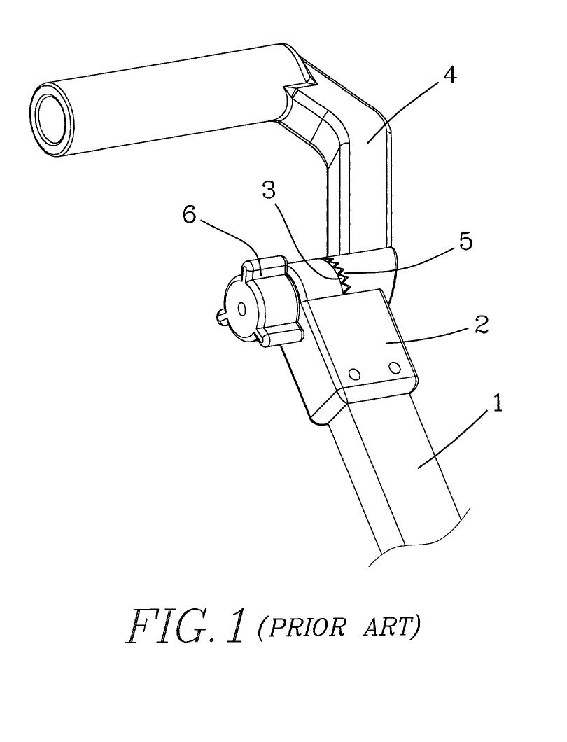

### DETAILED DESCRIPTION OF THE PREFERRED EMBODIMENT

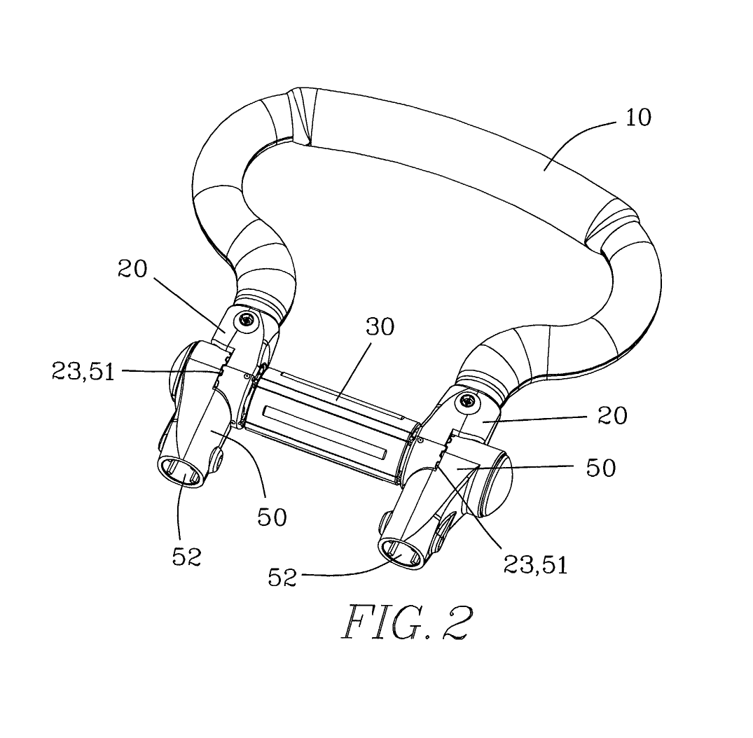

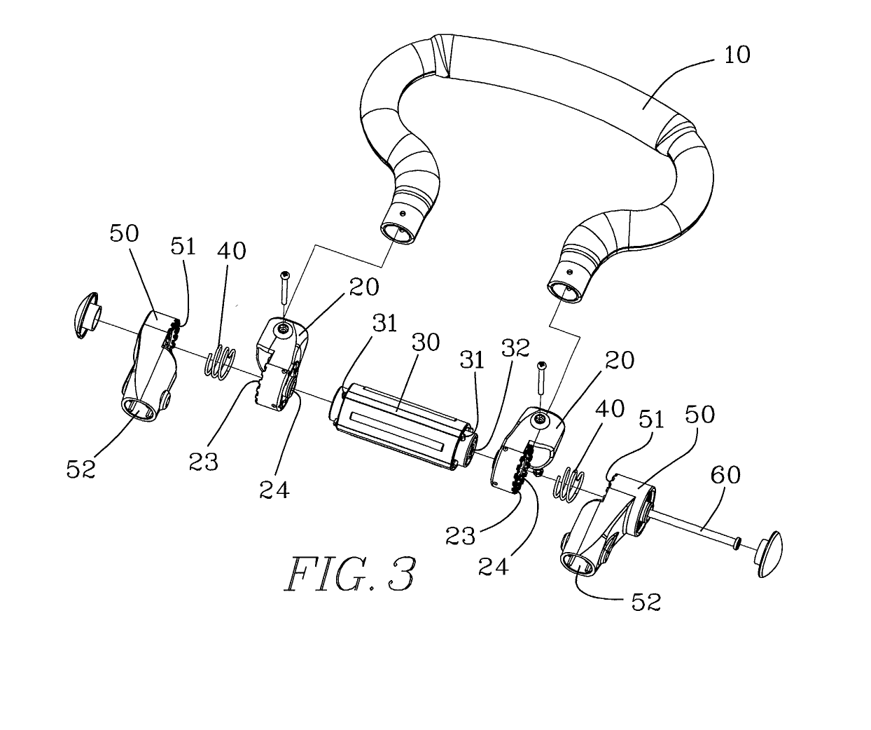

A preferred embodiment of an angle adjuster for the grip of a golf-cart, as shown in FIGS. 2 and 3, includes a grip 10, two rod bases 20, an adjusting member 30, two elastic members 40 and two connect bases 50 as main components combined together.

The grip 10 is shaped into an inverted U with two ends respectively fitted with the upper portions of two rod bases 20.

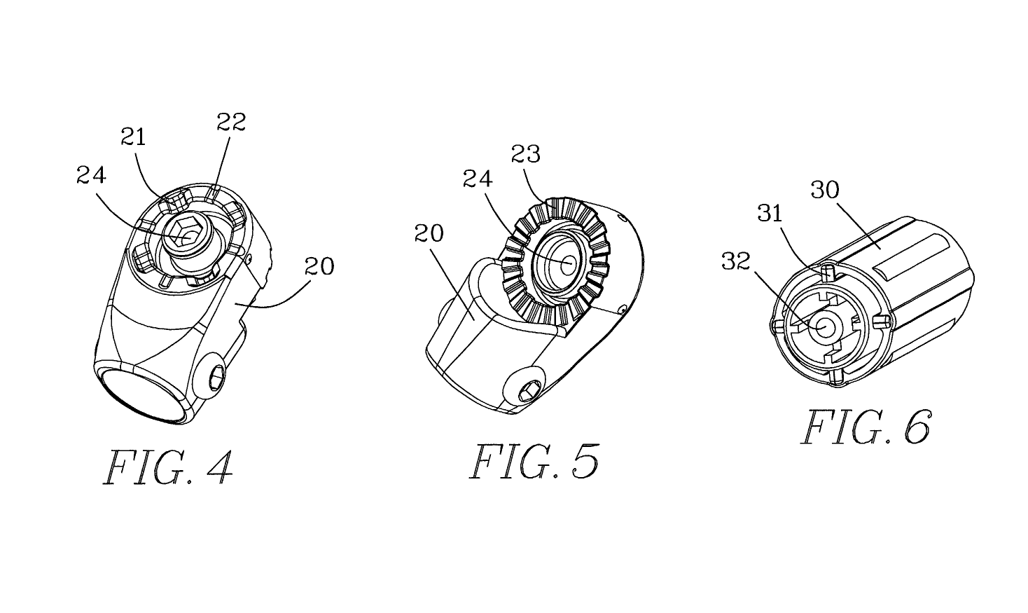

Two rod bases 20 respectively receive two ends of the grip 10, and two inner sides facing to each other, as shown in FIG. 4, having plural shallow grooves 21 and deep grooves 22 arranged spaced apart equidistantly and interposing one another annularly, while the back sides of the rod bases 20, as shown in FIG. 5, are respectively provided with an annular gear disc 23 and a shaft hole 24.

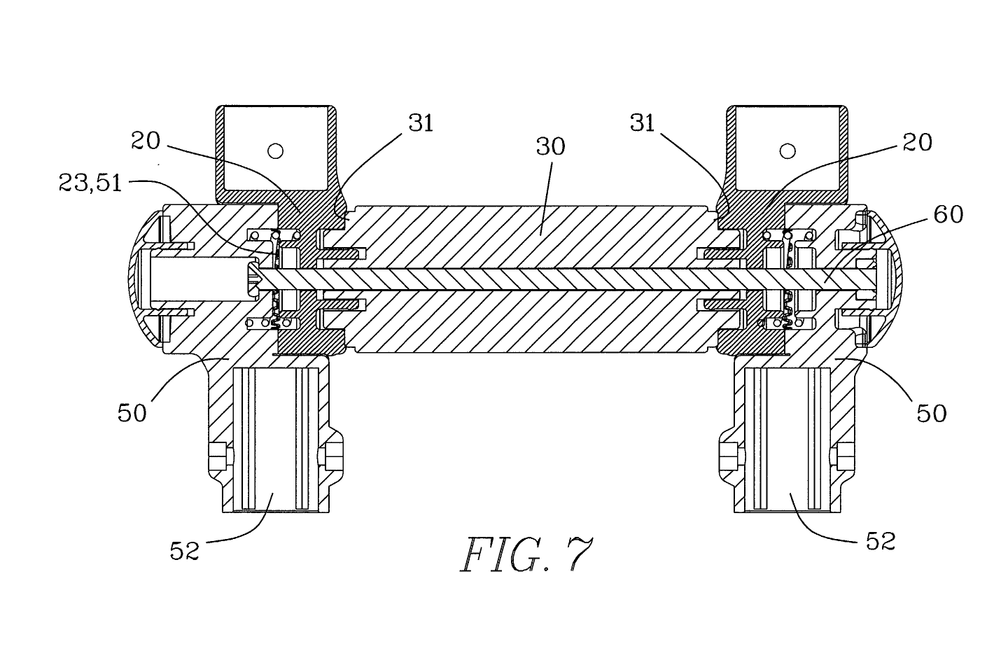

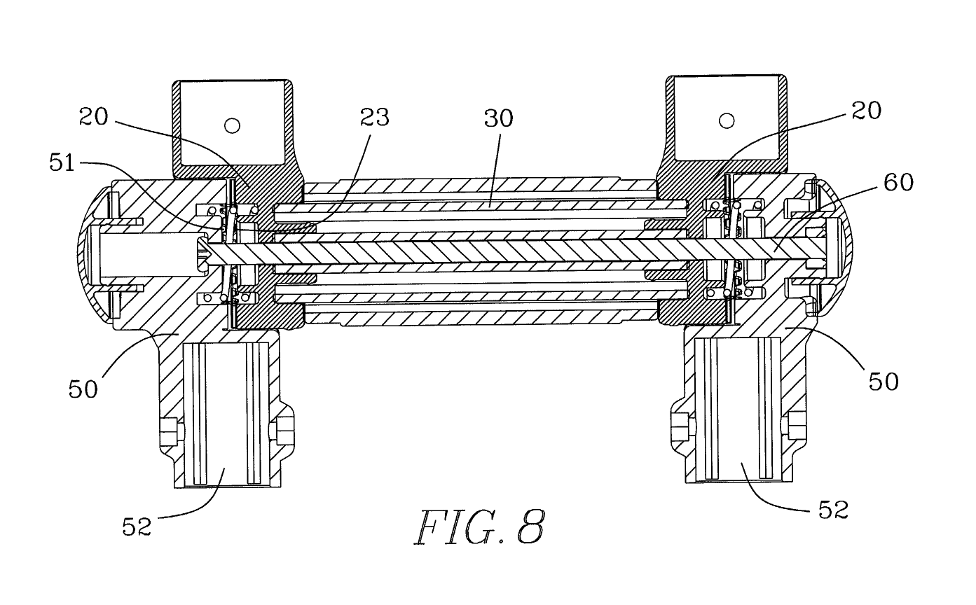

The adjusting member 30 has a rod outline, deposited between two rod bases 20, having projections around end side corresponding to the grooves 21, 22 of the rod bases 20. The protruding-out portion of the projection 31 is longer than the depth of the shallow groove 22 but shorter than that of the deep groove 21 of the rod bases 20. Thus, if the projections 31 are inserted into the shallow grooves 22 of the rod bases 20, the rod bases 20 will be pushed and expanded outward, as shown in FIG. 7, forming a distance about 106 mm long between the inner sides of two rod bases 20.But, if the projections 31 are inserted into the deep grooves 21 and on longer push against the rod bases 20, the width between two rod bases 20 reduces to about 101 mm, as shown in FIG. 8. In addition, the adjusting member 30 has shaft holes 32 corresponding to the shaft holes 24 of the rod bases 20.

Two elastic members 40 are respectively fitted within the inner side of each annular gear disc 23 of the rod bases 20.

Two connect bases 50 and the rod bases 20 sandwiching the elastic member 40 are combined in position by means of an elongate rod position member 60. Further, two connect bases 50 respectively have a gear disc 51 corresponding to the gear disc 23 of each rod base 20 and a joint opening 52 in the bottom side to receive other rod members.

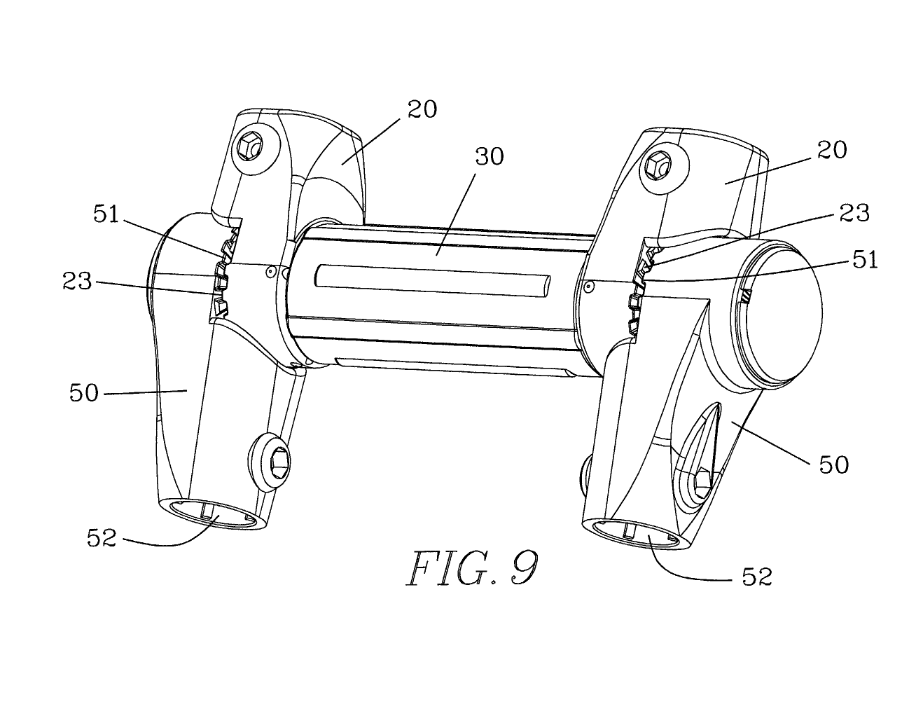

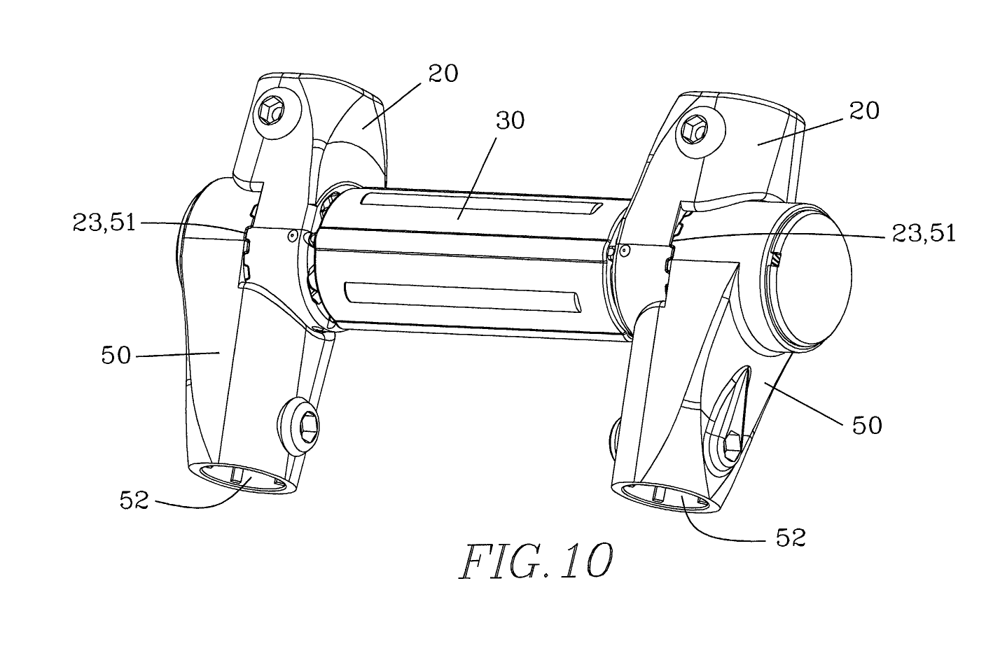

In using, when the grip 10 is to be adjusted for a certain angle, just turn the adjusting member 30 forward or backward a little to let the projection 31 of the adjusting member 30 not pushing against the relative shallow grooves 22 of the rod bases 20 so that the gear discs 23 of two rod bases 20 and the gear discs 51 of the connect bases 50 on longer engage each other, as shown in FIG. 9, thus convenient to adjust the angle a user requires. Then, the adjusting member 30 is turned a little again so as to force the projections 31 of the adjusting member 30 insert in the relative shallow grooves 22 of the rod bases 20 and push against two rod bases 20, as shown in FIG. 7 and 10, and the gear disc 23 of the rod bases 20 and the gear disc 51 of the connect bases 50 can be mutually engaged in place.

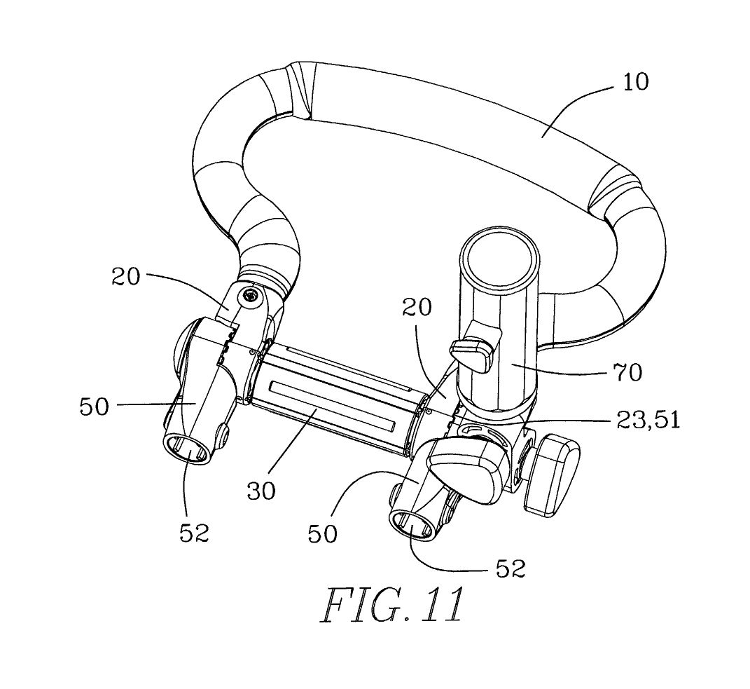

Besides, an umbrella holder 70 for placing an umbrella or the like can also be provided at an outer side of the connect base 50, as shown in FIG. 11.

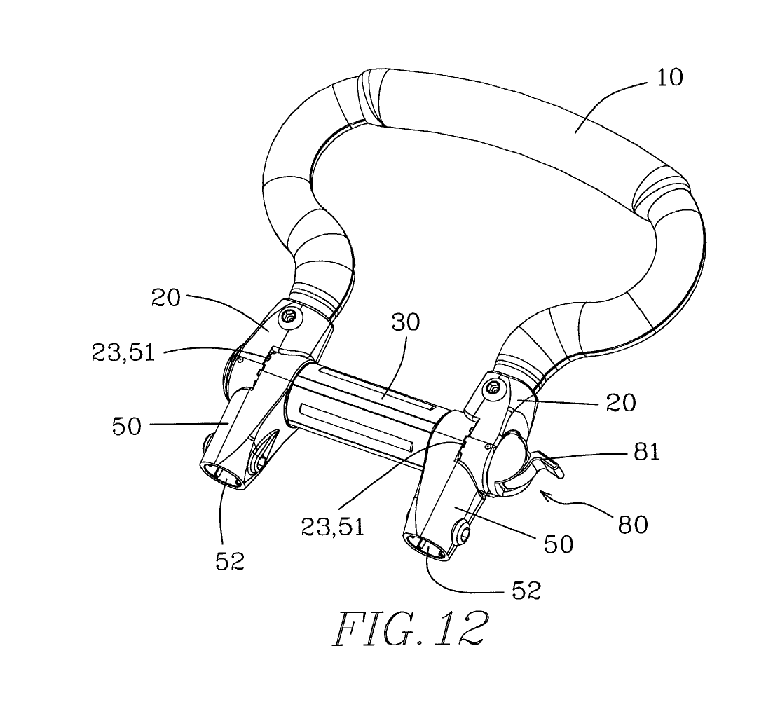

Furthermore, as shown in FIG. 12, the locations of the rod base 20 and the connect base 50 can. be exchanged in this invention. Under the exchanged condition, a position member 80 with an eccentric block 81 for compressing can be provided at the outer side of the rod base 20 to control the degree of mutual engagement between the gear discs 23 of the rod bases 20 and the gear discs 51 of the connect bases 50 by compressing or releasing the eccentric block 8 1 of the position member 80.

As can be understood from the above description, there are several advantages of this invention in adjusting angles of a grip:

1. The angle adjusting device of a grip 10 is located in the center portion so that it can be turned either clockwise or counterclockwise, needless to pay attention to direction of turning and thus removing the defect of a spiral base falling off in the known conventional device.

2. The design of variety is applicable, for instance, an umbrella holder can be additionally provided on the connect base.

3. Various locking systems can be employed and molds can be used commonly, For example, two different kinds of position members 60 and 80 can be applied in this invention.

While the preferred embodiment of the invention has been described above, it will be recognized and understood that various modifications may be made therein and the appended claims are intended to cover all such modifications that may fall within the spirit and scope of the invention.

I claim:

1. An angle-adjuster for the grip of a golf-cart comprising:
A grip shaped in an inverted U:
Two rod bases fixed with two ends of said grip, two sides facing to each other of said rod bases respectively having plural deep grooves and shallow grooves arranged spaced apart equidistantly and interposed to each other annularly, the back side of each said rod base provided with an annular gear disc having a shaft hole in a center:
An adjusting member provided between said two rod bases, having projections corresponding to said deep and shallow grooves of said rod bases, the protruding-out portion of said projection being longer than the depth of said shallow groove, but shorter than said deep groove:
Two elastic members respectively fitted in the inner side of said gear disc of said rod base:
Two connect bases compressing said elastic member and resting against said rod base, and a position member inserting through said connect bases, said elastic members and said rod bases to combine them in place, said connect bases respectively having gear discs corresponding to said gear discs of said rod bases for mutual engagement: and,
In handling, said adjusting member turned to let said projection push against said shallow groove of said rod base, forcing said gear disc of said rod base and said gear disc of said connect base tightly engaging each other in position; on the contrary, said projection inserted in said deep groove of said rod base to let two said gears disengaging from each other, thus facilitating adjustment of the angle of said grip.

2. The angle-adjuster for the grip of a golf-cart as claimed in claim 1, wherein an umbrella holder is provided at an outer side of said connect base.

3. The angle-adjuster for the grip of a golf-cart as claimed in claim 1, wherein the locations of said rod base and said connect base is exchanged and a position member with an eccentric block for applying pressure is provided at an outer side of said rod base.
